(19) United States
(12) Patent Application Publication
(10) Pub. No.: US 2007/0174692 A1
(43) Pub. Date: Jul. 26, 2007

(54) Image processing apparatus including function of backing up data by storing data in another device, backup program executed in image processing apparatus, and backup method

(75) Inventor: Kenichi Nagasawa, Takatsuki-shi (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Tokyo (JP)

(21) Appl. No.: 11/589,257

(22) Filed: Oct. 30, 2006

(30) Foreign Application Priority Data
Jan. 17, 2006 (JP) 2006-008787

(51) Int. Cl. G06F 11/00

(52) U.S. Cl. 714/13

(57) ABSTRACT

In order to reliably back up data in the event of a disaster, an MFP includes a data communication control unit for communicating with a backup device connected to LAN or the Internet, a warning reception unit acquiring a disaster occurrence signal output by a disaster warning detection unit, a data storage unit storing data, and a transmission control unit controlling the data communication control unit to transmit to the backup device data selected beforehand by a priority storing unit from the data stored in the data storage unit, when the disaster occurrence signal is received by the warning reception unit.

This application is based on Japanese Patent Application No. 2006-008787 filed with Japan Patent Office on Jan. 17, 2006, the entire content of which is hereby incorporated by reference.

### BACKGROUND OF THE INVENTION

1. Field of the Invention

The present invention relates to an image processing apparatus, a backup program, and a backup method, and more particularly to an image processing apparatus including a function of backing up data by storing data in another device, a backup program executed in the image processing apparatus, and a backup method.

2. Description of the Related Art

Recently, Multi Function Peripheral (referred to as MFP hereinafter) includes a hard disk as a mass storage device to allow storage of a variety of data, for example, such as billing data, print job data, address data for facsimile transmission, address data for emails, and historical data for storing transmission history. However, when disasters such as an earthquake, heavy rain, flood, or fire strike MFP, data stored in the hard disk is lost. It is therefore desirable to back up data by storing data in another storage device before it is lost. Japanese Laid-Open Patent Publication No. 2003-242045 discloses a method of carrying out backup saving, in which a server stores data in a user terminal into a database provided for the server. In this method, the server performs the steps of receiving backup determination information; determining whether or not backup saving is carried out based on the backup determination information; notifying the user terminal that the backup saving is to be performed; and performing the backup saving.

However, in the data backup method disclosed in Japanese Laid-Open Patent Publication No. 2003-242045, since the server stores the data in the user terminal into the database provided for the server, the server has to search for the data in the user terminal. Therefore, the load on the server increases as the number of user terminals increases. With increasing load on the server, it takes much time to carry out backup, making it impossible to save backups of data in all the user terminals before the user terminals are hit by a disaster.

### SUMMARY OF THE INVENTION

The present invention is made to solve the aforementioned problem. An object of the present invention is to provide an image processing apparatus capable of reliably backing up data in the event of a disaster.

Another object of the present invention is to provide a backup program and a backup method to allow an image processing apparatus to back up data reliably in the event of a disaster.

In order to achieve the objects described above, in accordance with an aspect of the present invention, an image processing apparatus includes: a communication unit to communicate with an external device connected to a network; an acquisition unit to acquire warning information about a disaster; a storage unit to store data; and a backup unit to control the communication unit to transmit at least part of the data stored in the storage unit to the external device when the warning information is acquired by the acquisition unit.

In accordance with another aspect of the present invention, a backup program is executed in an image processing apparatus including a communication unit for communicating with an external device connected to a network and a storage unit storing data. The backup program includes the steps of: acquiring warning information about a disaster; and controlling the communication unit to transmit at least part of the data stored in the storage unit to the external device when the warning information is acquired.

In accordance with a further aspect of the present invention, a backup method is performed in an image processing apparatus including a communication unit for communicating with an external device connected to a network and a storage unit storing data. The backup method includes the steps of: acquiring warning information about a disaster; and controlling the communication unit to transmit at least part of the data stored in the storage unit to the external device when the warning information is acquired.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing an entire overview of a data backup system in an embodiment of the present invention.

FIG. 2 is a block diagram showing an exemplary hardware configuration of MFP.

FIG. 3 is a functional block diagram showing an overall function of CPU of MFP together with information stored in HDD.

FIG. 4 shows an exemplary destination setting screen.

FIG. 5 shows exemplary destination information stored in a destination storing unit.

FIG. 6 shows an exemplary priority setting screen.

FIG. 7 is a flowchart illustrating a flow of a backup process performed in CPU of MFP, by way of example, in the embodiment of the present invention.

FIG. 8 is a flowchart illustrating a flow of a destination decision process by way of example.

FIG. 9 is a flowchart illustrating a flow of a backup transmission process by way of example.

FIG. 10 is a flowchart illustrating a flow of an alternative backup transmission process by way of example.

### DESCRIPTION OF THE PREFERRED EMBODIMENTS

In the following, an embodiment of the present invention will be described with reference to the figures. In the following description, the same parts will be denoted with the same reference characters. Their designations and functions are also the same. Therefore, the detailed description thereof will not be repeated.

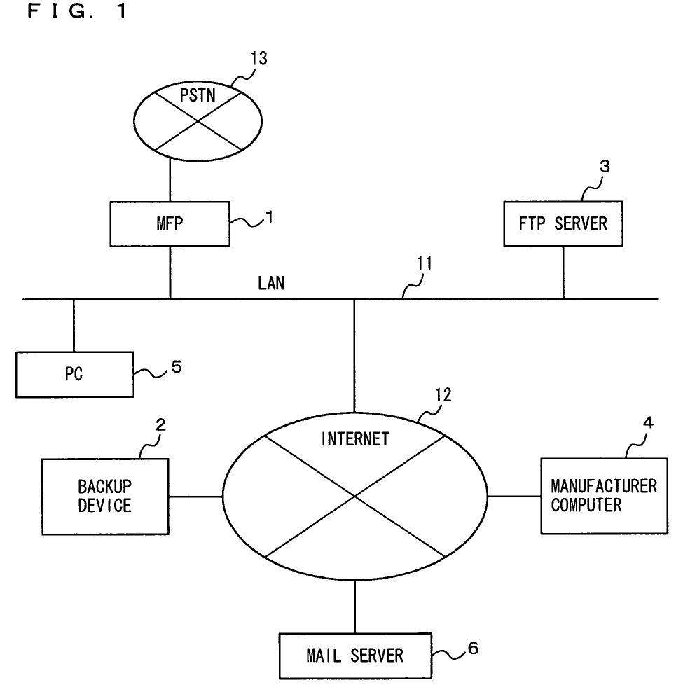

FIG. 1 is a diagram showing an entire overview of a data backup system in an embodiment of the present invention. Referring to FIG. 1, a data backup system includes an MFP (Multi Function Peripheral) 1 storing data to be saved for backup, a file transfer server (referred to as “FTP server” hereinafter) 3, and a personal computer (PC) 5, which are connected via a local area network (LAN) 11. LAN 11 is also connected to the Internet 12. Connected to the Internet 12 are a backup device 2 for saving a backup of data in MFP 1, a manufacturer computer 4 having the web site of the manufacturer of MFP 1, and a mail server 6 for receiving/transmitting emails.

Therefore, MFP 1 can communicate with FTP server 3 and PC 5 connected through LAN 11 and can also communicate with backup device 2, manufacturer computer 4, and mail server 6 connected through the Internet 12. MFP 1 is also connected to Public Switched Telephone Networks (PSTN) 13 to allow communications with a facsimile machine and the like connected to PSTN 13.

MFP1 includes a copy function, a scanner function, a facsimile reception/transmission function, a printing function, and a data storage function. MFP 1 includes a hard disk drive as a mass storage device for storing data in order to store a variety of data. MFP 1 has a backup setting so that data stored in the hard disk can be transmitted periodically to backup device 2 and its backup can be saved by backup device 2. It is noted that the backup setting is not essential, and without the backup setting, a backup is not periodically saved by backup device 2.

In the present embodiment, MFP 1, backup device 2, and manufacturer computer 4 are installed at locations geographically separated from each other. For example, a separation of at least a few tens of kilometers is desirable. Furthermore, FTP server 3 is desirably installed at a location geographically separated from MFP 1. However, if there is a constraint on the LAN cable, they are preferably installed in different buildings or at different floors, if installed in the same building.

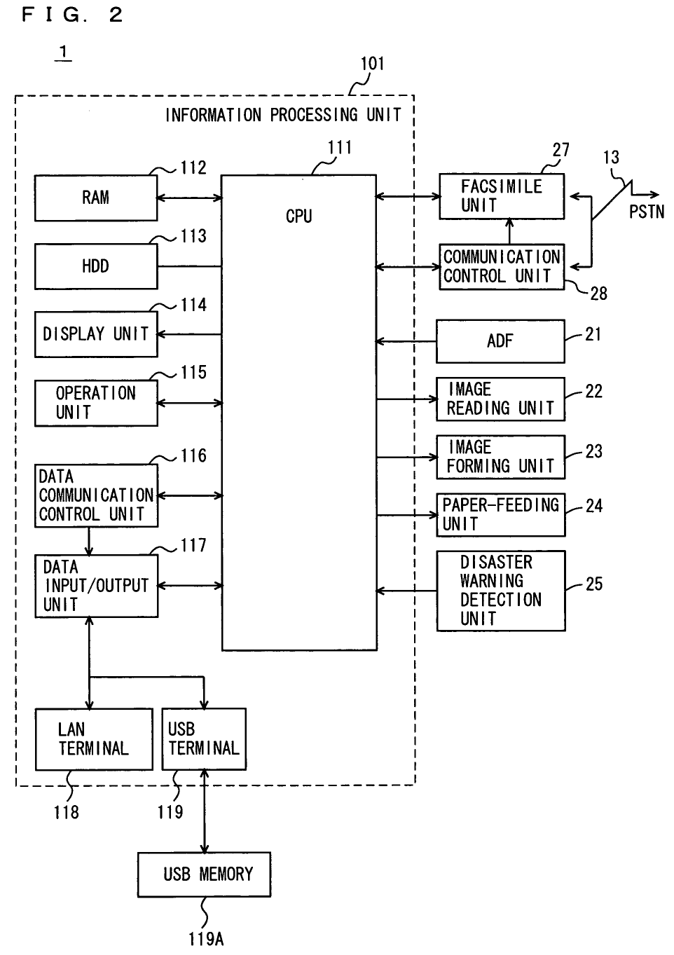

FIG. 2 is a block diagram showing an exemplary hardware configuration of MPF. Referring to FIG. 2, MFP 1 includes an information processing unit 101, a facsimile unit 27, a communication control unit 28, an automatic document feeder (ADF) 21, an image reading unit 22, an image forming unit 23, a paper-feeding unit 24, and a disaster warning detection unit 25. Information processing unit 101 includes a central processing unit (CPU) 111, an RAM (Random Access Memory) 112 used as a work area for CPU 111, a hard disk drive (HDD) 113 for storing data in a nonvolatile manner, a display unit 114, an operation unit 115, a data communication control unit 116, and a data input/output unit 117. CPU 111 is connected to each of data input/output unit 117, data communication control unit 116, operation unit 115, display unit 114, and HDD 113 to control information processing unit 101 as a whole. In addition, CPU 111 is connected to facsimile unit 27, communication control unit 28, ADF 21, image reading unit 22, image forming unit 23, paper-feeding unit 24, and disaster warning detection unit 25 to control MFP 1 as a whole.

Disaster warning detection unit 25 includes a sensor detecting primary wave(P-wave) primarily transmitted when an earthquake happens. Upon detection of P-wave, disaster warning detection unit 25 immediately outputs to CPU 111 a disaster occurrence signal indicating that P-wave is detected. Therefore, data can be backed up after P-wave is detected and before secondary wave (S-wave) as the second vibration arrive. Furthermore, disaster warning detection unit 25 is connected to a fire alarm in the building to receive fire occurrence information. Upon reception of the fire occurrence information, disaster warning detection unit 25 outputs a disaster occurrence signal to CPU 11. In addition, disaster warning detection unit 25 may receive disaster forecast information about heavy rain, flood, thunderbolt, earthquake, and the like provided by public or private disaster forecast institutions so that upon reception of the disaster forecast information, disaster warning detection unit 25 outputs a disaster occurrence signal to CPU 111. Information that warns the occurrence of disasters, such as P-wave, fire occurrence information, disaster forecast information, and the like as described above is collectively called “warning information”.

Display unit 114 is a display device such as a liquid crystal display (LCD) or Organic ELD (Electro Luminescence Display) to display instruction menus for the user, information on the acquired image data, and the like. Operation unit 115 includes a plurality of keys to receive inputs of data including a variety of instructions, characters, numerals through the user's operation corresponding to the keys. Operation unit 115 further includes a touch panel provided on display unit 114. Display unit 114 and operation unit 115 constitute an operation panel.

Data communication control unit 116 is connected to data input/output unit 117. Data communication control unit 116 controls data input/output unit 117 according to an instruction from CPU 111 to receive/transmit data from/to external equipment connected to data input/output unit 117. Data input/output unit 117 has an LAN terminal 118, a USB (Universal Serial Bus) terminal 119 serving as the interface for communications using a communication protocol such as TCP (Transmission Control Protocol) or FTP (File Transfer Protocol).

When MFP 1 has LAN terminal 118 connected with a LAN cable for connecting to LAN 11, data communication control unit 116 controls data input/output unit 117 to communicate with FTP server 3 and PC 5 connected through LAN terminal 118 and further communicate with backup device 2, manufacturer computer 4 and mail server 6 connected to LAN 11 via the Internet 12. MFP 1 receives data from PC 5 and stores the received data in HDD 113. MFP 1 also causes image forming unit 23 to print the data received from PC 5 based on an instruction from PC 5.

When equipment is connected to USB terminal 119, data communication control unit 116 controls data input/output unit 117 to communicate with the connected equipment for data input/output. USB terminal 119 is connectable with a USB memory 119A containing a flash memory. USB memory 119A stores a backup program described later, so that CPU 111 controls data communication control unit 116 to read the backup program from USB memory 119A and store the read backup program in RAM 112 for execution.

It is noted that the recording medium for storing the backup program is not limited to USB memory 119A and may be a medium that fixedly carries a program such as a flexible disk, a cassette tape, an optical disk (CD-ROM (Compact Disc-Read Only Memory)/MO (Magnetic Optical Disc)/MD (Mini Disc)/DVD(Digital Versatile Disc)), an IC card (including a memory card), an optical card, or a semiconductor memory such as a mask ROM, EPROM (Erasable Programmable ROM), EEPROM (Electronically EPROM). Alternatively, CPU 111 may download and store the backup program from manufacturer computer 4 into HDD 113, or manufacturer computer 4 may write the backup program in HDD 113, so that the backup program stored in HDD 113 is loaded into RAM 112 to be executed by CPU 111. The program referred to herein not only includes a program directly executable by CPU 111 but also includes a program in the form of a source program, a compressed program, an encrypted program, and the like.

Facsimile unit 27 is connected to PSTN 13 to transmit facsimile data to PSTN 13 or receive facsimile data from PSTN 13. Facsimile unit 27 stores the received facsimile data in HDD 113 and, in addition, converts the received facsimile data into print data that can be printed in image forming unit 23, to output the print data to image forming unit 23. Image forming unit 23 thereby prints the facsimile data received by facsimile unit 27 on a recording sheet. In addition, facsimile unit 27 converts the data stored in HDD 113 into facsimile data for transmission to FAX connected to PSTN 13.

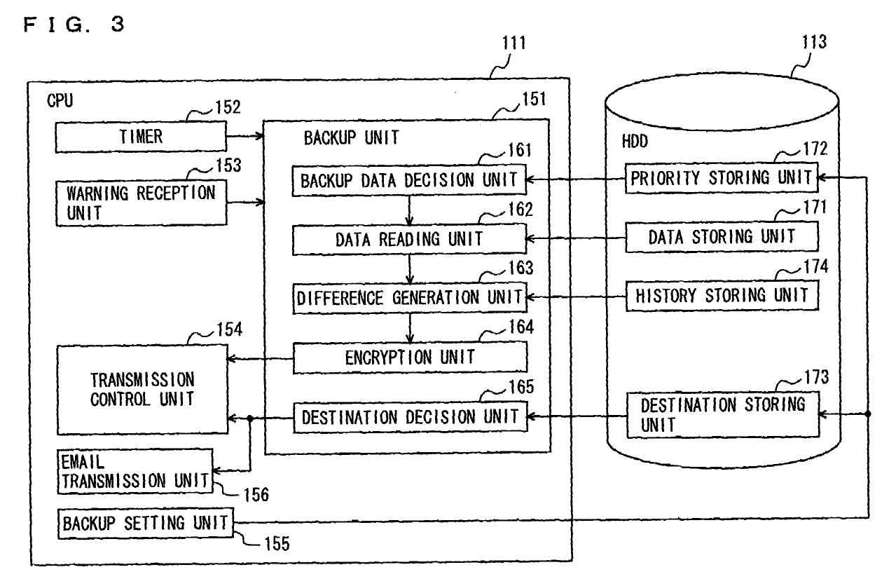

FIG. 3 is a functional block diagram showing the overall function of CPU of MFP with the information stored in HDD. Referring to FIG. 3, CPU 111 includes a timer 152 counting the time, a warning reception unit 153 receiving a disaster occurrence signal from disaster warning detection unit 25, a backup unit for backing up data stored in HDD 113, a transmission control unit 154 for transmitting data to be backed up, a backup setting unit 155 for receiving and storing the backup setting, and an email transmission unit 156 for transmitting an email.

Backup unit 151 performs a periodical backup process and an emergency backup process. The periodical backup process is a process for backing up data periodically according to the backup setting set by backup setting unit 155. Therefore, the periodical backup process is performed when the backup setting is set, but it is not performed when the backup setting is not set. The emergency backup process is a process that is performed independently of the periodical backup process for backing up data when a disaster occurrence signal is received by warning reception unit 153. Therefore, backup unit 151 performs the emergency backup process irrespective of whether or not the backup setting is set.

HDD 113 includes a data storage unit 171 storing data to be backed up, a priority storing unit 172 defining the kind and order of data to be backed up, a destination storing unit 173 for storing destination information defining a device or the like to which data to be backed up is transmitted, and a history storing unit 174 for storing history of data that has already been backed up through the periodical backup process.

History storing unit 174 stores the backed-up data and stores data that has been changed after being backed up with a change flag.

Backup setting unit 155 causes display unit 114 to display a destination setting screen for setting destination information necessary to transmit data to a device to which a backup of data is saved, and receives destination information input to operation unit 115 by the user for storage in destination storing unit 173 of HDD 113. Backup setting unit 155 also causes display unit 114 to display a priority setting screen for setting priority information defining selection of data to be backed up and the backup order, and receives priority information input to operation unit 115 by the user for storage in priority storing unit 172 of HDD 113.

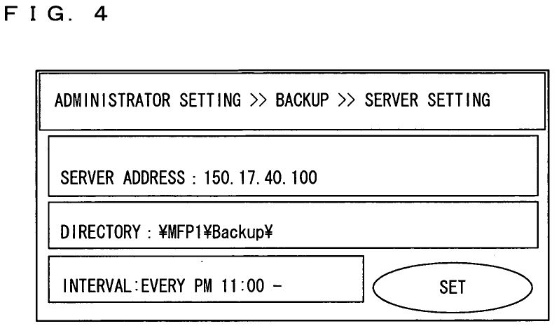

FIG. 4 shows a destination setting screen by way of example. Referring to FIG. 4, the destination setting screen includes a network address assigned to a device in which a backup of data is saved, a region (directory) in which data to be backed up is saved, and a region in which the backup time is input. The figure shows that data to be backed up is transmitted via FTP, where input in the destination setting screen are an IP address “150.17.40.100” assigned to backup device 2 as data necessary for transmission via FTP, “YMFP1YBackup” as a directory of the storage unit of backup device 2, and “every PM11:00-” as the backup time.

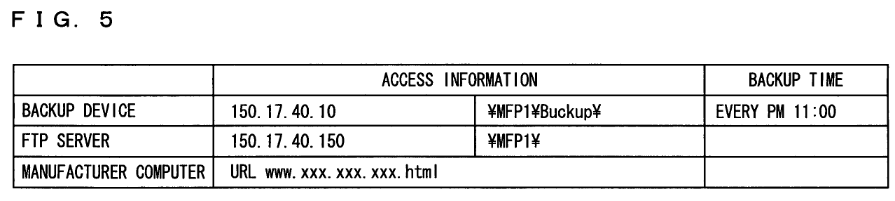

FIG. 5 shows destination information stored in the destination storing unit by way of example. Referring to FIG. 5, the destination information includes a device name of a backing-up device, access information, and backup time, which are related with one another. In the figure, in addition to the destination information of backup device 2, the respective destination information of FTP server 3 and manufacturer computer 4 are stored in destination storing unit 173, by way of illustration. The access information of backup device 2 is the IP address of backup device 2 required to transmit data via FTP and the directory. The destination information of FTP server 3 is stored in destination storing unit 173 when FTP function is set valid in MFP 1. Therefore, when FTP function is not set valid in MFP 1, the destination information of FTP server 3 is not stored in destination storing unit 173. In the destination information of FTP server 3, the access information is the IP address of FTP server 3 and the directory, and the backup time is blank. The destination information of manufacturer computer 4 is stored in destination storing unit 173 at the time when MFP 1 is shipped. In the destination information of manufacture computer 4, the access information is URL (Uniform Resource Locator) indicative of the Internet site of manufacture computer 4, and the backup time is blank.

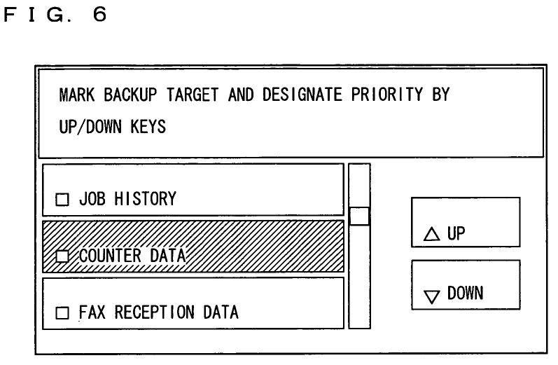

FIG. 6 shows a priority setting screen by way of example. Referring to FIG. 6, in the priority setting screen, the data kinds of data to be backed up among a plurality of data kinds are arranged in order of backup and are displayed from top. Here, the data kinds of job history, counter data, and FAX transmission data are selected as data to be backed up, and the order of backup is determined in the order of job history, counter data, FAX transmission data. The order can be changed by selecting a data kind using a touch panel and giving an instruction using UP key or DOWN key.

Returning to FIG. 3, backup unit 151 performs a periodical backup process on the condition that the backup setting is set. If the destination information of backup device 2 is stored in destination storing unit 173, backup unit 151 performs a backup transmission process when the time counted by timer 152 indicates the backup time of the destination information. On the other hand, when a disaster occurrence signal is received by warning reception unit 153, backup unit 151 performs an emergency backup process. Upon reception of a disaster occurrence signal, backup unit 151 performs a backup transmission process if the destination information of backup device 2 is stored in destination storing unit 173. However, if the destination information of backup device 2 is not stored in destination storing unit 173, backup unit 151 performs an alternative backup process. In other words, upon reception of a disaster occurrence signal, backup unit 151 performs a backup transmission process if the backup setting is set, and backup unit 151 performs an alternative backup transmission process if the backup setting is not set.

Backup unit 151 includes a backup data decision unit 161 for deciding data to be backed up based on the priority information stored in priority storing unit 172, a data reading unit 162 reading the data decided to be backed up from data storage unit 171, a difference generation unit 163 generating a difference from data backed up in the past, an encryption unit 164 encrypting and outputting the difference to transmission control unit 154, and a destination decision unit 165 deciding a destination to transmit data to be backed up and outputting the same to transmission control unit 154.

If the backup setting is set, backup data decision unit 161 decides data to be backed up based on the priority information stored in priority storing unit 172 and outputs identification information including the file name of the decided backup data and the like to data reading unit 162. If the backup setting is not set, the priority information is not stored in priority storing unit 172, and thus backup data decision unit 161 decides data to be backed up based on the priority information defined by default and outputs the identification information including the file name of the decided backup data and the like to data reading unit 162.

Data reading unit 162 reads data with the file name input from backup data decision unit 161 from data storage unit 171 and outputs the same to difference generation unit 163.

If historical information is stored in history storing unit 174, difference generation unit 163 determines whether or not there has been a change based on the change flag stored in history storing unit 174. If the change flag is not added, difference generation unit 163 discards data input from data reading unit 162. If the change flag is added, difference generation unit 163 reads the previously backed-up data from history storing unit 174, calculates the difference from the data input from data reading unit 162, and outputs the difference to encryption unit 164. If historical information is not stored in history storing unit 174, difference generation unit 163 outputs the data input from data reading unit 162 to encryption unit 164 as it is.

Encryption unit 164 encrypts the data or difference input from difference generation unit 163 and outputs the encrypted data to transmission control unit 154. It is noted that the difference may be compressed to reduce the amount of transmitted data. In this case, the compressed data is encrypted for transmission.

Destination decision unit 165 reads destination information from destination storing unit 173 to decide a destination device and outputs a transmission instruction to transmission control unit 154. Specifically, if the destination information of backup device 2 is stored in destination storing unit 173, destination decision unit 165 outputs the access information of backup device 2 to transmission control unit 154 and instructs transmission control unit 154 of transmission via FTP. On the other hand, if the destination information of backup device 2 is not stored and the destination information of FTP server 3 is stored in destination storing unit 173, destination decision unit 165 outputs the access information of FTP server 3 to transmission control unit 154 and instructs transmission control unit 154 of transmission via FTP. If neither destination information of backup device 2 and FTP server 3 is stored in destination storing unit 173, destination decision unit 165 outputs the access information of the manufacturer computer to transmission control unit 154 and instructs transmission control unit 154 of transmission via a predetermined protocol.

Transmission control unit 154 transmits the encrypted data input from encryption unit 164 to a destination device according to a transmission instruction input from destination decision unit 165. If an alternative backup process is performed by backup unit 151, email transmission unit 156 generates and transmits to mail server 6 an email directed to an email address stored in HDD 113 beforehand, including information for specifying the destination to which backed-up data is transmitted. The email address stored in HDD 113 beforehand is preferably an email address assigned to the administrator of MFP 1. Therefore, the administrator of MFP 1 refers to the email to learn a device in which a backup of data is saved.

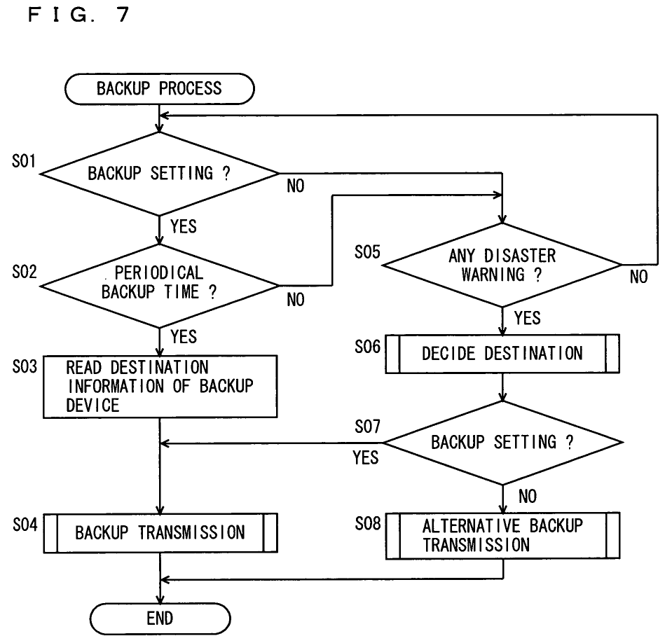

FIG. 7 is a flowchart illustrating a flow of a backup process performed in CPU of MFP, by way of example, in accordance with the present embodiment. Referring to FIG. 7, CPU 111 determines whether or not the backup setting is set (step SO 1). If the destination information of backup device 2 is stored in destination storing unit 173, CPU 111 determines that the backup setting is set, and the process proceeds to step S02. On the other hand, if the destination information of backup device 2 is not stored, it is determined that no backup setting is set, and the process proceeds to step S05.

At step S02, CPU 111 proceeds to step S03 when a periodical backup time has come. If not a periodical backup time, CPU 111 proceeds to step S05. CPU 111 determines that a periodical backup time has come when the time counted by timer 152 indicates the backup time of the destination information of backup device 2. At step S03, the destination information of backup device 2 is read from destination storing unit 173. Then, at step S04, a backup transmission process is performed, and then the process ends. The backup transmission process will be described later.

On the other hand, CPU 111 determines whether or not a disaster warning has been given, at step S05. If a disaster occurrence signal has been received by warning reception unit 153, CPU 111 proceeds to step S06. If not, the process returns to step S01. At step S06, a destination decision process is performed. The destination decision process, which will be described later, is a process of deciding a device for backing up data and setting destination information.

At step S07, similarly to step S01, it is determined whether or not the backup setting is set. If the backup setting is set, the process proceeds to step S04. If the backup setting is not set, the process proceeds to step S08. At step S08, an alternative backup process is performed, and the process then ends. The alternative backup process will be described later.

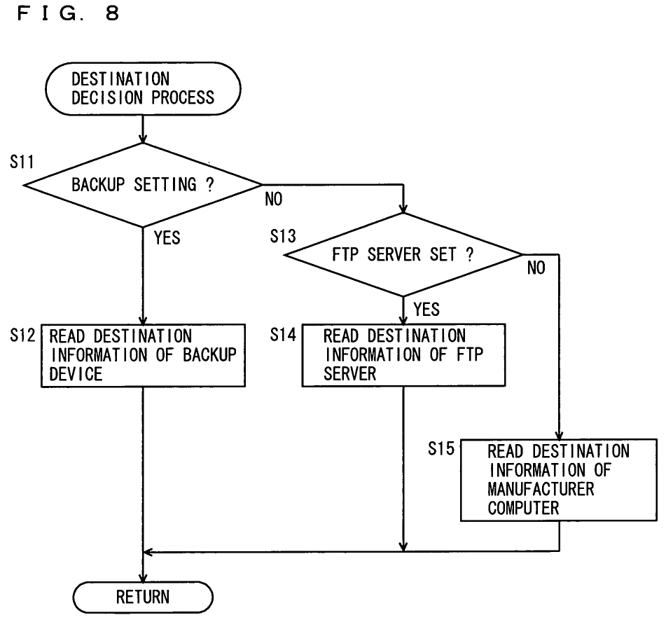

FIG. 8 is a flowchart illustrating a flow of a destination decision process by way of example. Referring to FIG. 8, CPU 111 determines whether or not the backup setting is set (step S11), and if the backup setting is set, the process proceeds to step S12. If the backup setting is not set, the process proceeds to step S13. At step S12, the destination information of backup device 2 is read from destination storing unit 173, and the process returns to the backup process.

At step S13, it is determined whether or not FTP server is set (step S13). If the destination information of FTP server 3 is stored in destination storing unit 173, CPU 111 determines that FTP server is set. If not stored, CPU 111 determines that FTP server is not set. At step S14, the destination information of FTP server 3 is read from destination storing unit 173, and the process returns to the backup process. At step S15, the destination information of the manufacturer computer is read from destination storing unit 173, and the process returns to the backup process.

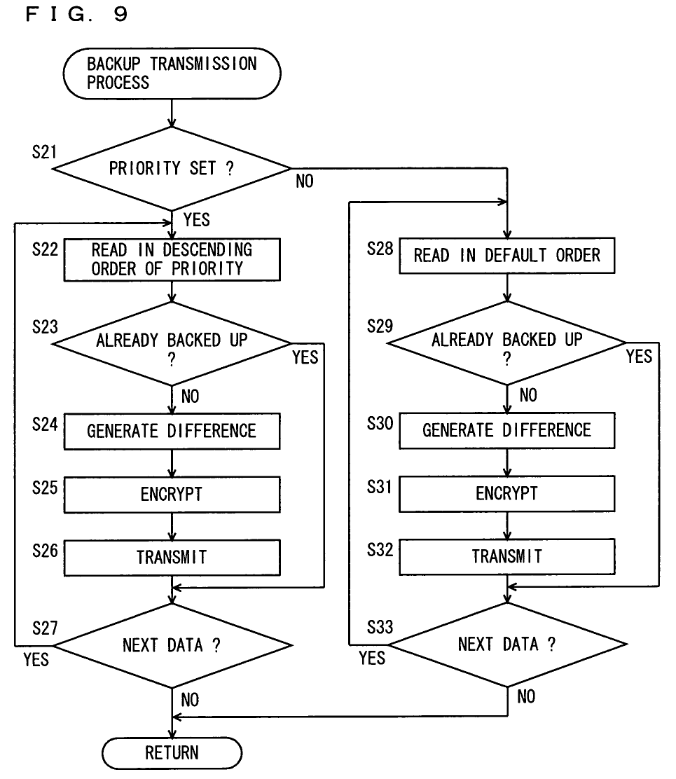

FIG. 9 is a flowchart illustrating a flow of a backup transmission process by way of example. Referring to FIG. 9, CPU 111 determines whether or not priorities are set (step S21). If the priority information is stored in priority storing unit 172, CPU 111 determines that priorities are set and reads the priority information, and then the process proceeds to step S22. If the priority information is not stored in priority storing unit 172, it is determined that priorities are not set, and the process proceeds to step S28. At step S22, data to be backed up is read from data storage unit 171 in descending order of priority according to the read priority information.

Then, it is determined whether or not the read data has already been backed up (step S23). If the historical information of the read data does not include a change flag, CPU 111 determines that the read data has already been backed up, and the process proceeds to step S27. If the historical information of the read data includes a change flag, the previously backed-up data is read from history storing unit 174, and then the process proceeds to step S24.

At step S24, a difference between the data read at step S22 and the previously backed-up data read at step S23 is generated. Then, the generated difference is encrypted to generate encrypted data (step S25). The encrypted data is transmitted to backup device 2 according to the destination information read at step S03 in FIG. 7 or the destination information read at step S12 in FIG. 8 when the destination decision process is performed (step S26). At step S27, CPU 111 determines whether or not next data to be processed exists, and if any, the process returns to step S22. If not, the process returns to the backup process. It is noted that if the historical information of the data read at step S22 does not exist in history storing unit 174, the data itself is encrypted (step S25) and transmitted to backup device 2 (step S26).

On the other hand, at step S28, CPU 111 reads data to be backed up from data storage unit 171 in descending order of priority according to default priority information. The default priority information is stored in HDD 113 beforehand. The process from step S29 to step S33 is the same as the process from step S23 to step S27, and therefore the description will not be repeated here.

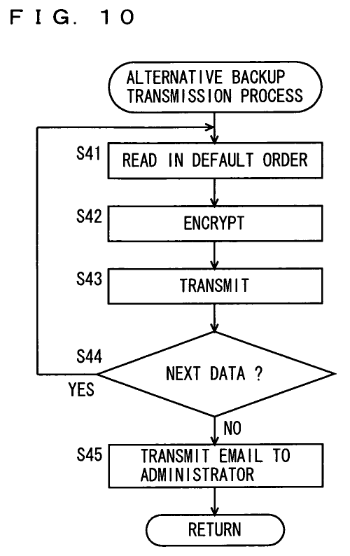

FIG. 10 is a flowchart illustrating a flow of an alternative backup transmission process by way of example. Referring to FIG. 11, the process from step S41 to step S44 is the same as the process from step S28 to step S33 in FIG. 9, and therefore the description will not be repeated here. The alternative backup transmission process is performed when it is determined at step S07 in FIG. 7 that the backup setting is not set. Thus, the destination of transmission of data at step S43 is FTP server if FTP server is set, and it is manufacturer computer 4 if FTP server is not set. Therefore, even if the backup setting is not set in MFP 1, data can be backed up. Then, at step S45 when transmission of data to be backed up is completed, CPU 111 generates and transmits to mail server 6 an email directed to an email address stored in HDD 113 beforehand, including information for specifying the destination to which backed-up data is transmitted. Thus, the administrator of MFP 1 refers to the email to learn the device in which a backup of data is saved.

As described above, MFP 1 in accordance with the present embodiment includes data communication control unit 116 for communicating with backup device 2 connected to LAN 11 or the Internet 12, warning reception unit 153 receiving a disaster occurrence signal output by disaster warning detection unit 25, data storage unit 171 storing data, and transmission control unit 154 controlling data communication control unit 116 such that data selected beforehand in priority storing unit 172 among data stored in data storage unit 171 is transmitted to backup device 2, when warning reception unit 153 has received a disaster occurrence signal. Accordingly, data is transmitted before MFP 1 is damaged by a disaster, so that data loss can be prevented. In addition, since disaster warning detection unit 25 includes a sensor detecting P-wave, data can be backed up before S-wave arrives after P-wave is detected.

Moreover, history storing unit 174 distinguishes between data that has been backed up through a periodical backup process and data that has not been backed up, for storage. Therefore, data that has been backed up will not be backed up, while as for the data that has not been backed up, only the difference from the previously backed-up data is transmitted, thereby reducing the transmission time of data.

In addition, data is transmitted in the order defined by the priority information stored in priority storing unit 172, so that data with a higher priority is backed up reliably.

Furthermore, data is encrypted for transmission to ensure data security.

What is more, when the backup setting is not set, data to be backed up is transmitted to FTP server 3, if FTP server 3 is set. If FTP server 3 is not set, data to be backed up is transmitted to the predetermined Internet site of manufacturer computer 4. Therefore, even when the backup setting is not set, data can be backed up.

It is noted that although in the foregoing embodiment, MFP 1 has been described, the present invention can be understood as a backup program causing CPU 111 of MFP 1 to perform the backup process illustrated in FIGS. 7 to 10 or as a backup method causing MFP 1 to perform the backup process illustrated in FIGS. 7 to 10.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image processing apparatus comprising:
a communication unit to communicate with an external device connected to a network;
an acquisition unit to acquire warning information about a disaster;
a storage unit storing data; and
a backup unit to control said communication unit so as to transmit at least part of said data stored in said storage unit to said external device when said warning information is acquired by said acquisition unit.

2. The image processing apparatus according to claim 1, wherein
said backup unit includes a periodical backup unit to control said communication unit so as to periodically transmit at least part of said data stored in said storage unit to said external device,
said storage unit includes a history storing unit to store data backed up by said periodical backup unit,
said backup unit includes a difference generation unit to generate a difference between said data stored in said storage unit and said data backed up by said periodical backup unit, and
said communication unit is controlled to transmit said generated difference.

3. The image processing apparatus according to claim 2, wherein
said storage unit includes a priority information storing unit to store priority information including a priority assigned to said stored data, and
said backup unit controls said communication unit to transmit said data stored in said storage unit in descending order of said priority.

4. The image processing apparatus according to claim 1, wherein
said storage unit includes a priority information storing unit to store priority information including a priority assigned to said stored data, and
said backup unit controls said communication unit to transmit said data stored in said storage unit in descending order of said priority.

5. The image processing apparatus according to claim 4, further comprising a reception unit to receive an input of a priority to be assigned to said data stored in said storage unit.

6. The image processing apparatus according to claim 1, wherein said backup unit includes an encryption unit encrypting said data.

7. The image processing apparatus according to claim 1, further comprising a setting unit to receive a setting of destination information for transmitting said data to said external device.

8. The image processing apparatus according to claim 7, further comprising a destination information storing unit to store beforehand destination information of a device different from said external device, wherein
said backup unit controls said communication unit to transmit said data according to the destination information stored in said destination information storing unit when said destination information is not set by said setting unit.

9. The image processing apparatus according to claim 8, wherein
said destination information storing unit includes an FTP destination information storing unit to store destination information of an FTP server connected to said network, and
said backup unit controls said communication unit to transmit said data to said FTP server.

10. The image processing apparatus according to claim 8, wherein
said destination information storing unit includes an Internet site storing unit to store destination information of an Internet site of a manufacturer connected to the Internet, and
said backup unit controls said communication unit to transmit said data to said Internet site.

11. A backup program stored on a computer-readable medium and executed in an image processing apparatus including a communication unit to communicate with an external device connected to a network and a storage unit to store data, said backup program comprising the steps of
acquiring warning information about a disaster; and
controlling said communication unit to transmit at least part of said data stored in said storage unit to said external device when said warning information is acquired.

12. A backup method performed in an image processing apparatus including a communication unit for communicating with an external device connected to a network and a storage unit storing data, said backup method comprising the steps of
acquiring warning information about a disaster; and
controlling said communication unit to transmit at least part of said data stored in said storage unit to said external device when said warning information is acquired.

13. The backup method according to claim 12, wherein
said controlling step includes a periodical backup step of controlling said communication unit to periodically transmit at least part of said data stored in said storage unit to said external device,
said storage unit includes a history storing unit storing data backed up at said periodical backup step, and
said controlling step includes the steps of
generating a difference between said data stored in said storage unit and said data backed up at said periodical backup step, and
controlling said communication unit to transmit said generated difference.

14. The backup method according to claim 13, wherein
said storage unit includes a priority information storing unit storing priority information including a priority assigned to said stored data, and
said controlling step includes the step of controlling said communication unit to transmit said data stored in said storage unit in descending order of said priority.

15. The backup method according to claim 12, wherein
said storage unit includes a priority information storing unit to store priority information including a priority assigned to said stored data, and
said controlling step includes the step of controlling said communication unit to transmit said data stored in said storage unit in descending order of said priority.

16. The backup method according to claim 15, further comprising the step of receiving an input of a priority to be assigned to said data stored in said storage unit.

17. The backup method according to claim 12, wherein said controlling step includes the step of encrypting said data.

18. The backup method according to claim 12, further comprising the step of receiving a setting of destination information for transmitting said data to said external device.

19. The backup method according to claim 12, wherein
said storage unit further includes a destination information storing unit to store beforehand destination information of a device different from said external device, and
said controlling step includes the step of controlling said communication unit to transmit said data according to the destination information stored in said destination information storing unit when said destination information is not set at said step of receiving a setting.

20. The backup method according to claim 19, wherein
said destination information storing unit includes an FTP destination information storing unit to store destination information of an FTP server connected to said network, and
said controlling step includes the step of controlling said communication unit to transmit said data to said FTP server.

21. The backup method according to claim 19, wherein
said destination information storing unit includes an Internet site information storing unit to store destination information of an Internet site of a manufacturer connected to the Internet, and
said controlling step includes the step of controlling said communication unit to transmit said data to said Internet site.
